(19) United States
(12) Patent Application Publication
(10) Pub. No.: US 2020/0230924 A1
(43) Pub. Date: Jul. 23, 2020

(54) LAMINATED GLAZING HAVING A FUNCTIONAL FILM

(71) Applicant: Central Glass Co., Ltd., Yamaguchi (JP)

(72) Inventors: Wladislaw Bronstein, Trier (DE); Steven Scott Christman, Goodlettsville, TN (US); Michael Bard, Primm Springs, TN (US)

(73) Assignee: Central Glass Co., Ltd., Yamaguchi (JP)

(21) Appl. No.: 16/747,739

(22) Filed: Jan. 21, 2020

Related U.S. Application Data
(60) Provisional application No. 62/795,643, filed on Jan. 23, 2019.
(60) Provisional application No. 62/877,342, filed on Jul. 23, 2019.

(51) Int. Cl. B32B 17/10; G02B 5/26; G02B 27/01; B32B 7/12; G03H 1/02; G02F 1/1334; G02B 5/20; G02F 1/1333

(52) U.S. Cl. CPC B32B 17/10504; G02B 5/26; G02B 27/0103; B32B 17/10036; G02B 27/0101; B32B 7/12; G02F 2001/133302; G03H 1/0252; G02F 1/1334; B32B 17/10926; B32B 17/10779; G02B 5/208; B32B 2307/71; B32B 17/10761

(57) ABSTRACT

A laminated glass product, according to the present disclosure, includes a first glass substrate, a second glass substrate, a polymer interlayer laminated between the first glass substrate and the second glass substrate, a functional film, such as a head-up display film, a printed film, and a switchable film, laminated between the first glass substrate and the second glass substrate, and a thin adhesive layer formed on the functional film between the functional film and one of the first and second glass substrates, for efficiently laminating such a functional film with improved lamination quality.

### CROSS REFERENCES TO RELATED APPLICATIONS

This application claims benefit under 35 U.S.C. § 1.119(b) of U.S. provisional patent application Ser. No. 62/795,643, filed Jan. 23, 2019, entitled ADHESIVE FILM FOR LAMINATED GLASS PRODUCTS and also of U.S. provisional patent application Ser. No. 62/877,342, filed Jul. 23, 2019 entitled LAMINATED GLAZING FOR HEAD UP DISPLAY, the entire contents of both of which are incorporated herein in their entirety.

### TECHNICAL FIELD

The present disclosure generally relates to a laminated glazing having a functional film laminated between at least two glass substrates.

### BACKGROUND

A laminated glass construction may include functional films laminated between glass substrates for various purposes. For instance, switchable films may be provided in, for example, architectural and automotive glazings. Films may be further provided in automotive glazings for head up display applications. A switchable film may be selectively switched from an opaque or dark state to a transparent state by an electric current. An electrical connection maybe placed within the glass construction to communicate with the switchable material. When an electric current is applied, the switchable material transfers from an opaque state to a transparent state or vice versa. The switchable material may change back to its opaque or transparent state when the electric current is no longer applied to the material. Switchable materials may include polymer dispersed liquid crystal (PDLC), polymer network liquid crystal (PNLC), suspended particle device (SPD), and electrochromic constructions.

Functional films may further include coated films for interacting with infrared light. Such films may reflect or absorb infrared light to reduce the total light energy which passes through the glass to an interior space, such as a vehicle. Such films may include a polymer film, such as polyethylene terephthalate, which may be coated prior to lamination in a glazing. It is known that solar radiation of the sun reaching Earth consists of 3% ultraviolet rays (UV), 55% infrared radiation (IR), and 42% visible light. When light strikes glass, it may be partially reflected, partially absorbed in the glass, and partially transmitted through the glass. The total solar energy transmittance Tₜₛ through the glazing may be used to measure the solar performance of a glazing. It may be preferable to minimize solar energy transmitted through a glazing, as a minimal Tₜₛ may indicate fuel efficiency gains from reduced air-conditioning use due to less solar radiation and heat in the vehicle. The lower the Tₜₛ value, the more energy efficient the vehicle becomes, as less solar energy builds up in an interior. Tₜₛ may be calculated on the basis of ISO 13837-2008 “Road vehicles—Method of the determination of solar transmittance.” Infrared reflective (IRR), such as silver-based coatings, or absorbing (IRA), such as indium tin oxide (ITO) based nanoparticles, technologies may be used to decrease Tₜₛ.

Functional films, for these and other uses, are desirable in laminated glazings. Thus, there is a need in the art for efficiently laminating such films with improved lamination quality.

### SUMMARY OF THE DISCLOSURE

The present disclosure relates generally to a laminated glass product, comprising a first glass substrate, a second glass substrate, a polymer interlayer laminated between the first glass substrate and the second glass substrate, a film laminated between the first glass substrate and the second glass substrate, and an adhesive layer formed on the film between the film and one of the first and second glass substrates, having a thickness less than 0.05 mm.

In some embodiments, the film may be printed or comprise a switchable film, or a holographic film. Where printed, the film may be formed with opaque frame around an outer periphery thereof. Where the film is switchable, the switchable film may be made of a polymer dispersed liquid crystal film. In some embodiments, the adhesive layer may be made of a polyvinyl butyral layer, and the adhesive layer can be formed from a sprayable adhesive. In some embodiments, the film desirably has a thickness of 0.01 to 0.30 mm, preferably from 0.03 to 0.25 mm, more preferably from 0.05 to 0.15 mm.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 illustrates a laminated glazing with a film laminated therein according to a first exemplary embodiment of this disclosure;

FIG. 2 illustrates a laminated glazing with a film laminated therein, according to a second exemplary embodiment of this disclosure; and

FIG. 3 illustrates deviations in a laminated glazing according to a second exemplary embodiment of this disclosure.

### DETAILED DESCRIPTION

In the following description, for purposes of explanation, specific details are set forth to promote a thorough understanding of one or more aspects of the disclosure. It may be evident in some or all instances, however, that many aspects described below can be practiced without adopting the specific design details described below.

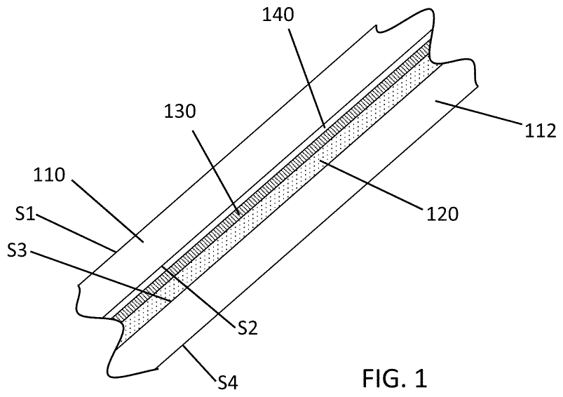

For purposes of this disclosure, where a glazing is an automotive glazing, including with reference to FIG. 1, a S1 surface of a first glass substrate (an “outer glass substrate”) faces a vehicle exterior, a surface S2 of the first glass substrate is on a side of the first glass substrate opposite of the S1 surface. A S3 surface of a second glass substrate (an “inner glass substrate”) and the S2 surface are inside a laminated glazing, and a S4 surface of the second glass substrate is opposite the S3 surface and faces a vehicle interior.

The disclosure herein is directed to a laminated glazing having at least one film laminated therein, and methods of making thereof.

A conventional laminated glazing may include a first glass substrate and a second glass substrate which may be laminated together with a polymer interlayer. The glass substrates may be any suitable glass, including soda-lime-silica glass, which may be defined by ISO 16296-1:2008. Clear, green, tinted, or privacy-colored glass from 0.33 to 3.0 mm thick may be preferable. The glass substrates may initially be flat and heat treated to be bent and/or tempered. The bending process may include heating at 560 to 700° C. or preferably from 600 to 650° C. The polymer interlayer may be one or more layers and may have an even thickness or have varying thickness, such as a polymer interlayer having a wedged-angle. A polymer interlayer may be any suitable material, which may include polyvinyl butyral (PVB), ethylene vinyl acetate (EVA), or an ionomer interlayer. The lamination process may include autoclaving, during which the glass substrates with the polymer interlayer therebetween are heated to at least one laminating temperature and pressure (for example, 110 to 160° C. and 10 to 15 bar) to laminate the glass substrates together.

Laminated glass products may further include a film laminated therein for various functions. The film may include, among other forms, a thin material which may not hold up to heat and pressure of an autoclave when sandwiched between two soft polymer interlayers. Typical polymer interlayers, including PVB, may be pliable, especially at temperatures above the PVB softening point and at pressures common in autoclaving procedures. Under pressure, a softened, thick PVB interlayer may not maintain the shape of a film sandwiched by the PVB. In a typical construction, the PVB interlayer may be at least 0.3 mm in thickness. Thus, in a laminated glazing having a thin film core surrounded by polymer interlayers, the film core may wrinkle or otherwise include imperfections due to the lamination process. Among other things, an object of the present disclosure is to solve the aforementioned problems.

The laminated film, as described herein, may include any film suitable to laminate in a glazing, including functional films. Functional films may include, without limitation, switchable films (e.g., polymer dispersed liquid crystal (PDLC), polymer network liquid crystal (PNLC), suspended particle devices (SPD), electrochromic films), printed films, films for head up display, including functional retarder films, polarized light reflective films and holographic films, and coated films having light reflective or absorbing properties, including ultraviolet (UV) and/or infrared (IR) frequencies.

Switchable films may include PDLC, PNLC, SPD, or electrochromic films. A switchable film may include a switchable material sandwiched between conductive layers and polymer films. The thickness of a switchable film may vary depending on the thickness of each layer in the film. For example, without limitation, PDLC film may have a thickness from 0.1 to 0.4 mm and PNLC film may have a thickness from 0.05 to 0.2 mm. The polymer films of the switchable film may be any suitable thickness.

Further films to be laminated in a glazing may include printed films. Typically, a glass lamination includes printing on at least one glass substrate which may be applied by screen printing on the glass substrate(s) prior to lamination. The printing may be undesirable for various reasons, including processing limitations and changes to a glass substrate during the bending process around a painted area of the substrate. In general, the preparation of a glazing may include opaque enamel prints printed by, for example, screen-printing on flat glass substrates. The printed glass may then be bent at temperatures from 500-700° C., wherein the opaque enamel prints are fired at such temperatures to form a rigid print with high mechanical durability. In such manufacturing processes, the opaque enamel printing materials, such as black enamel paint, and the glass substrate, such as a transparent or semi-transparent soda-lime silica glass which may be defined by ISO 16293-1:2008, may display different physical properties such as light absorptance, elastic modulus or coefficient thermal expansion. For example, a black-colored opaque enamel print typically absorbs much more heat in a furnace than the glass substrate, resulting in inhomogeneous temperature distribution in the glass substrate. Temperatures in areas of the glass substrate near the black-colored opaque enamel printed area may be locally higher than those areas far from the printing. Moreover, differences may exist between the coefficients of thermal expansion (CTE) of the black-colored opaque enamel printing and the soda-lime silica glass substrate, resulting in residual stress after the glass substrate and opaque enamel print are cooled down. For at least these reasons, the optical distortions near the opaque enamel printing may be created by heat treatment of the printed glass substrates.

To address the printing problems, among other reasons, a darkened area, for example, surrounding the periphery of a laminated glazing or around a camera or sensor opening, may be provided by laminating a printed film in a laminated glazing. A laminated printed film may be used with or without a printed glass substrate. The printed film may include the same or different paints or inks as those which may be used on a glass substrate. For example, without limitation, PET (polyethylene terephthalate) or PVC (polyvinyl chloride) film may be printed using black or blue colored ink and such films may have 0.01-0.4 mm thickness.

Further laminated films may include head-up display (HUD) films, such as a retarder film, polarized light reflective film and holographic film. Holographic films and technology may be used in various HUD technologies, including Augmented Reality (AR) HUD technologies. Such films may be laminated in a glazing to facilitate the use of light projections to provide visual information to a driver. It may be preferable to laminate head up display film used in such systems in the glazing. Various laminated films may be laminated in a glazing for HUD applications, including polarization, reflective, or holographic films. The laminated films may be used with particular projectors in some embodiments where the film may be used with a particular type of light, include particular wavelengths or direction of projected light.

In some embodiments, laminated films may include a functional coating, which may include light blocking properties such as infrared reflective or infrared absorbing properties. The total light transmitted through a glazing may preferably be minimized to reduce power used by a vehicle to compensate for solar power in an interior vehicle space. For example, the power required by an air conditioner may decrease where less solar power is transmitted through a glazing into an interior space. It may be appreciated that various coatings, such as a silver layered infrared reflective (IRR) coating, may be applied to a film within a laminated glazing to reduce the light transmitted therethrough. For example, without limitation, a PET film may be coated with an IRR coating comprising metallic silver sub-layers or indium oxide sub-layers. Films may be laminated in a glazing for these and other uses and may include any functional coatings thereon.

In some forms, the laminated film may provide deviations which may be formed during the lamination process. The deviations may be visible in a laminated glazing and may have a textured appearance. Deviations may refract light differently from a flat film, which may change the angle of light passing therethrough, scattering light and distorting the appearance of the laminate. Deviations may be formed, for example, by wrinkling of the film or local displacement of the film. Limiting the deviations in a glazing may be preferable to provide a suitable glazings in a vehicle. Particularly, for HUD applications, limiting deviations in a laminated glazing may increase the possible viewing angle of a projection. As such, drivers having various heights may be able to use a head-up display system in a single vehicle.

For any of these or other laminated films, the thickness of the laminated film may be related to the amount of wrinkling which may be formed during the lamination process, as a thicker film may be more likely to withstand the heat and pressure during lamination. Further, a thicker film may be provided within an interlayer such that a layer of interlayer provides a frame around the thicker film which is also sandwiched between two interlayer sheets. Preferably, an interlayer frame is used where the film is at least 0.35 mm thick to protect the lamination from breaking at the film's edge where a change in laminate thickness would otherwise occur. Further, a thicker film laminated together adjacent an interlayer may create sharp thickness inhomogeneity, resulting in breakage of glass substrates during the lamination process or at least mechanical (and hence optical) distortion in the laminated glazing. It may instead be desirable to laminate a thin film within a glazing. The process to frame a film with an interlayer costs time and money in production to provide the additional interlayer material and to align the materials between two glass substrates and additional interlayers. A thin, flexible film may more readily form to the three-dimensional contours of bent glass substrates. Further, a thin film may provide a lighter weight film for lamination than alternative thicker films. A light weight construction may be preferable where overall weight is preferably reduced. Preferably, the film used in laminated glazings disclosed herein may be from 0.01 to 0.3 mm, more preferably the film is from 0.03 to 0.25 mm, and more preferably the film is from 0.05 to 0.15 mm. Further, the film may be located within a portion of the lamination or across the entire laminated construction. The size of the laminated film may depend on the intended use. For example, a film having IRR function may cover the entire surface, and, on the other hand, a film providing function to an area of the glazing through which a camera collects information may not be required across the entire glazing. The laminated film may have any suitable material, such as PET, PVC, or cellulose triacetate (TAC).

A film laminated within a glazing may require adhesive to provide adhesion to glass substrates. As discussed herein, it may not be desirable to laminate the film between two polymer sheets having a thickness of at least 0.3 mm. The inventor surprisingly found that a thinner adhesive layer may provide an adhesive solution to address issues experienced with laminating thin films, such as wrinkling. Under pressure, a thin adhesive layer may allow the laminated film to press against a glass substrate through the thin adhesive layer, which may reduce wrinkling defects. The film core is able to contour to the shape of the glass substrate as the thin adhesive layer may not be thick enough to maintain the film at least partially separated from the glass substrate. The thin adhesive layer may preferably equal to or less than 0.05 mm thick, more preferably equal to or less than 0.03 and more preferably equal to or less than 0.01 mm thick.

The thin adhesive layer may be preferably formed as a spray applied onto the surface of either a glass substrate or a film. The thin adhesive layer is preferably transparent and adheres to both a glass substrate and a film to be laminated within glass substrates even after heat and pressure treatment during lamination. Preferably, the adhesive may include polyvinyl butyral (PVB). For example, without limitation, PVB-based aerosol spray (PVB 60 Varnish, Termo Pasty) can be used. The thin adhesive layer may be a non-tacky adhesive, such that the adhesive is not tacky during handling, prior to curing. A tacky adhesive upon application may not provide suitable lamination qualities, including de-airing. Preferably, the adhesive layer is constructed with the glass substrates and a film as a stack, which may then be heated and put under pressure to laminate the materials together. Preferably, the adhesive may not have adhesive properties prior to curing or partial curing. Further, the thin adhesive may preferable have no plasticizers. Plasticizers are typically included in an adhesive sheet to increase pliability of the adhesive sheet. A relatively thinner adhesive may not require plasticizers as the thin adhesive film has sufficient pliability. The thin nature of the material may increase pliability and handling. Adding plasticizers may increase pliability and decrease the ability to handle the material, as it may not easily retain a sheet form.

FIG. 1 illustrates an exemplary laminated glazing having a first glass substrate 110 and a second glass substrate 112 laminated together with a polymer interlayer 120, a film 130, and a thin adhesive layer 140 therebetween. The film 130 may be any suitable film for lamination, including a single or multilayer film. In some embodiments, the film 130 may include a switchable film, a printed film, a head up display film, or an otherwise coated film.

A method of producing a laminated glazing as disclosed herein may include, bending the first and second glass substrates 110, 112 to a desired shape and aligning an interlayer 120 on one of the first and second glass substrates 110, 112. The film 130 may then be layered onto the interlayer 120 and coated with a thin adhesive layer 140. The thin adhesive layer 140 may be sprayed onto the film 130. In some embodiments, the thin adhesive layer 140 may be preferably applied to the film 130 prior to stacking the film in the laminate. In further embodiments, the thin adhesive layer 140 may be preferably formed on one of the first and second glass substrates 110, 112. The remaining glass substrate 110, 112 may then be aligned with the laminate stack and the construction may be laminated, including autoclaving.

### Example 1

A first 2.1 mm thick soda-lime glass substrate and a second 2.1 soda-lime glass substrate were stacked together with a PVB polymer interlayer having 0.81 mm thickness, a PDLC switchable film having 0.12 mm thickness, and a thin sprayed PVB adhesive layer having less than 0.01 mm thickness therebetween. Such a glazing construction was laminated together, including a de-airing process using a vacuum bag and an autoclaving process. The laminated glazing showed no wrinkling in the laminated PDLC film.

### Example 2

First and second soda-lime glass substrates 1.8 mm thick may be stacked together with a PVB polymer interlayer having 0.76 mm thickness, printed PET film having 0.1 mm thickness, and thin sprayed PVB adhesive layer having 0.01 mm thickness therebetween. The printed PET film may be printed with a black ink. Such a glazing construction may be laminated together, including a de-airing process using a vacuum bag and an autoclaving process. The laminated glazing may show few or no wrinkles in the laminated PET film.

Preferably, the thin adhesive layer is between the laminated film and a S3 surface of a second glass substrate, such that the thin adhesive layer is between the film and a vehicle interior. An outer, thicker adhesive layer may include additives, such as ultraviolet (UV) absorbing particles. Some films which may be laminated in the glazing may be sensitive to UV exposure. The UV absorbing particles in an outer adhesive layer may protect the laminated film as well as a vehicle interior. UV light from sun exposure may be absorbed be an outer adhesive layer with UV absorbing particles when the adhesive is placed between a glazing exterior facing surface and a laminated film. Further, the thin adhesive layer may not be suitable for UV absorbing particles. As the adhesive thickness decreases, UV absorbing particles would take a larger percentage of space in the adhesive layer to provide adequate protection, which may affect the adhesive quality of the material.

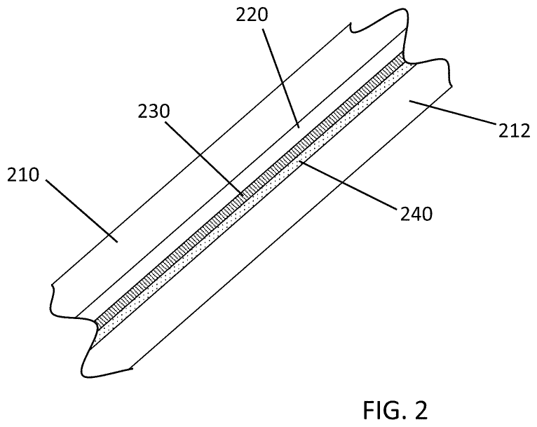

FIG. 2 illustrates an exemplary laminated glazing having a first glass substrate 210 and a second glass substrate 212 laminated together with a first interlayer 220, a film 230, and a second, thin interlayer 240 therebetween. The film 230 may be any suitable film for lamination.

A method of producing a laminated glazing as disclosed herein may include, bending the first and second glass substrates 210, 212 to a desired shape and aligning a first interlayer 220 on one of the first and second glass substrates 210, 212. The first interlayer 220 may be at least 0.35 mm thick, preferably the first interlayer 220 is from 0.35 mm to 0.85 mm thick. The film 230 may then be layered onto the interlayer 220 and covered with a second, thin interlayer 240. The second interlayer 240 may be thinner than the first interlayer 220. In some embodiments, the second interlayer 240 may be preferably laminated to the film 230 prior to stacking the film in the laminate. In further embodiments, the second interlayer 240, the film 230, and the first interlayer 220 may be laminated together prior to lamination of the glazing. The remaining glass substrate 210, 212 may then be aligned with the laminate stack and the construction may be laminated, including de-airing and autoclaving.

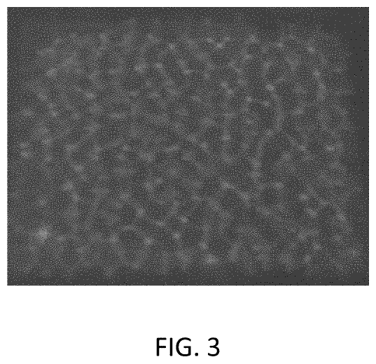

FIG. 3 shows deviations in a laminated glazing. Particularly, FIG. 3 illustrates light transmitted through and scattered by the deviations in the glazing. Embodiments as described herein may minimize the deviations and light scattered by the lamination.

In the description above, for purposes of explanation and not limitation, the examples with specific details are set forth to provide a thorough understanding of the present disclosure. However, it will be apparent to those having ordinary skill in the art that other embodiments with various modifications and variations may be practiced without departing from the spirit and scope of the present disclosure.

Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. A laminated glass product, comprising:
a first glass substrate;
a second glass substrate;
a polymer interlayer laminated between the first glass substrate and the second glass substrate;
a film laminated between the first glass substrate and the second glass substrate; and
an adhesive layer between the film and one of the first and second glass substrates, having an thickness less than 0.05 mm.

2. The laminated glass product according to claim 1, wherein the film is printed.

3. The laminated glass product according to claim 2, wherein the film includes an opaque frame around an outer periphery of the film.

4. The laminated glass product according to claim 1, wherein the film comprises a switchable film.

5. The laminated glass product according to claim 4, wherein the switchable film is a polymer dispersed liquid crystal film.

6. The laminated glass product according to claim 1, wherein the film comprises an infrared reflective material.

7. The laminated glass products according to claim 1, wherein the film comprises a polyethylene terephthalate film.

8. The laminated glass product according to claim 1, wherein the adhesive layer comprises a polyvinyl butyral layer.

9. The laminated glass product according to claim 1, wherein the adhesive layer is formed from a sprayable adhesive.

10. The laminated glass product according to claim 1, wherein the film comprises a thickness of 0.01 to 0.30 mm.

11. The laminated glass product according to claim 10, wherein the film has the thickness from 0.03 to 0.25 mm.

12. The laminated glass product according to claim 11, wherein the film has the thickness from 0.05 to 0.15 mm.

13. The laminated glass product according to claim 1, wherein the film comprises a HUD film.

14. The laminated glass product according to claim 1, wherein the film comprises a holographic film.

15. A method for producing a laminated glass product, comprising the steps of:
providing a first glass substrate, an interlayer on the first glass substrate, a film on the interlayer, an adhesive layer having a thickness equal to or less than 0.05 mm on the film, and a second glass substrate on the adhesive layer to provide a glazing stack;
de-airing the glazing stack; and
autoclaving the glazing stack to provide a laminated glass product.

16. The method for producing a laminated glass product according to claim 15, wherein the adhesive layer is formed on the film.

17. The method for producing a laminated glass product according to claim 15, wherein the adhesive layer is sprayed onto the film.

18. The method of producing a laminated glass product according to claim 15, wherein the adhesive layer comprises a polyvinyl butyral layer.

19. The method of producing a laminated glass product according to claim 15, wherein the adhesive layer is formed on the second glass substrate.

20. The method of producing a laminated glass product according to claim 19, wherein the adhesive layer is sprayed onto the second glass substrate.
